(19) United States
(12) Patent Application Publication
(10) Pub. No.: US 2005/0066824 A1
(43) Pub. Date: Mar. 31, 2005

(54) Produce corer

(76) Inventors: Richard S. Brown, Chualar, CA (US); Raymond C. Ash, Salinas, CA (US); Michael E. Ellis JR., Hollister, CA (US)

Correspondence Address: HOWREY SIMON ARNOLD & WHITE, LLP, c/o IP DOCKETING DEPARTMENT, 2941 FAIRVIEW PARK DRIVE, SUITE 200, FALLS CHURCH, VA, 22042-2924, US

(21) Appl. No.: 10/894,863

(22) Filed: Jul. 19, 2004

Related U.S. Application Data
(60) Provisional application No. 60/488,468, filed on Jul. 18, 2003.

(51) Int. Cl. A47J 23/00

(52) U.S. Cl. 99/547

(57) ABSTRACT

An apparatus for cutting and removing the cores of produce such as fruit or leafy vegetables, particularly cabbage or lettuce, prior to the processing of the vegetable. The apparatus has a coring tube, a shaft, and a chisel, where the coring tube is attached to the distal end of the shaft, and the proximal end of the shaft is inserted into the pneumatic chisel. The coring tube has a cylindrical coring blade at its distal end, which is inserted into the fruit or vegetable to be cored using a rapid linear and/or rotational oscillation motion provided by an electric or pneumatic driver. Cut portions of the fruit or vegetable can be removed from the proximal end of the coring tube.

### CROSS REFERENCE TO RELATED APPLICATIONS

The present application claims priority to U.S. Provisional Patent Application Ser. No. 60/488,468 filed Jul 18, 2003, the contents of which are incorporated herein by reference.

### FIELD OF THE INVENTION

The invention relates generally to an apparatus and method for removing the cores of fruits and vegetables. In particular, a vegetable corer is disclosed that can be held in the hand and used to form a cavity in a variety of fruits and vegetables with a minimal amount of effort, thereby facilitating easy removal of the core.

### DESCRIPTION OF RELATED ART

Salad processors increasingly rely on pre-cored leafy vegetables delivered to their processing lines. Common in the U.S. packaged salad industries are field-cored iceberg and romaine lettuces. Similarly, cabbage is increasingly required to be pre-cored for delivery to processing plants. However, cabbage is more difficult to field-core due to the dense nature of the head and the difficulty associated with using common field coring tools, such as hand-held knives having a variety of modifications such as elongated and/or curved blades.

A variety of tools and apparatus are known for coring vegetables such as lettuces, cabbage, and cauliflower in the field, prior to processing. The softer, leafy vegetables exemplified by lettuces such as iceberg and romaine are commonly cored with a stainless steel coring tube. Such tubes are typically about two inches in diameter, but can vary depending upon the size of the core to be removed. Because lettuce typically has a soft inner core, the coring tube will easily penetrate the core when thrust into the area of the lettuce surrounding the core. With such a tool, the core remains in the tube for easy removal when the tube is withdrawn from the lettuce.

Cabbage, on the other hand, is a hard, dense vegetable, requiring a different approach to coring. In the use of hand tools, several hard thrusts are often required in order to remove the core, and often such hand tools only allow for the core to removed a small piece at a time. A person coring cabbage and other similar vegetables with such hand tools faces potential injury. Not only can muscle stress and nerve injury result from the repeated pushing required to core a vegetable with such a tool, but in the event that an immature cabbage having a soft interior is encountered, the tube can easily penetrate the entire cabbage and enter the person's other hand, which is holding the cabbage.

Alternative methods of coring such vegetables, and especially cabbage, have consequently been developed. One such method involves cutting the cabbage in half vertically from the top of the vegetable through the center with a knife. The interior core section can then be cut away from the usable portion of the cabbage with such common tools as a paring knife. However, this approach suffers from being both time-consuming and requiring a larger, sharp knife or a machete for the initial step of dividing the head in half, the use of which can lead to injuries.

Methods for efficient coring have also been incorporated directly into the processing plants themselves, where cabbage, lettuce, and other vegetables such as cauliflower are cored using horizontally mounted drill presses. In such a typical apparatus, an operator holds the cabbage head by hand and advances it against a rapidly rotating corer similar to a drill bit. The bit can be mounted horizontally or vertically, and carves out the core area of the head. A disadvantage of using such instruments is their cost, as well as the safety issues pertaining to clothing, or occasionally body parts, becoming caught in the drill press machinery.

Attempts have been made to adapt such drill-press type machinery as described above to field applications. However, such adaptations create an increased danger for persons operating the machinery in the field. Unlike the stable, permanently mounted drill presses in processing plants, field adaptations are often mounted to decks attached to trucks or trailers, which constantly move throughout the crop fields during the harvesting. Given that the terrain is often uneven due to precipitation, soil moisture, and/or previous machinery operations in the fields, the deck-mounted drill press is often on unstable terrain and can move in an unpredictable manner, resulting in an increased incidence of injury.

Disadvantages of earlier approaches to coring apparatus thus include cost, time consumption, and often the possibility of injury due to the use of sharp knives. Thus, there exists a need for a safer, cheaper, and more efficient tool for coring produce including vegetables such as lettuce, cabbage, and cauliflower, as well as fruits such as pineapple, in the field or in the processing plant.

### SUMMARY OF THE INVENTION

An aspect of the present invention is a safe, efficient apparatus useful for coring produce in a safer, more efficient manner with minimal effort to the operator and a reduced risk of operator injury. The apparatus includes a pneumatic chisel having a chisel shaft driven by a pneumatic power source, and a coring tube attached to the distal end of the chisel shaft. The coring tube includes a hollow center such that the separated core can be quickly and easily removed from the apparatus.

A further aspect of the present invention is a easy, rapid and efficient method of separating the core from produce using an apparatus as described above, and further provides that the separated core can be easily and safely removed from the produce and discarded, such that the apparatus can continue to be used. The method comprises using a tool such as described briefly above, aligning the coring tube against the core of the piece of produce, applying a slight pressure with the tube against the core; activating the pneumatic driving apparatus, deactivating the pneumatic apparatus when the desired depth is attained, and dislodging and discarding the inner core from the outer body of the item of produce.

### DESCRIPTION OF THE FIGURES

The following figures form part of the present specification and are included to further demonstrate certain aspects of the present invention. The invention may be better understood by reference to one or more of these figures in combination with the detailed description of specific embodiments presented herein.

FIG. 1A illustrates an embodiment of the present disclosure.

FIG. 1B is an alternative view of coring tube 10 and chisel shaft 50 of FIG. 1A.

FIG. 2A is an elevated view of coring tube 10, looking towards proximal end 40 along chisel shaft 50.

FIG. 2B is a side view of coring tube 10 showing its attachment in relation to chisel shaft 50.

FIG. 2C is a top perspective view of an alternate embodiment of the coring blade which is attached to the distal end of the chisel shaft.

FIG. 2D is a front perspective view of an alternative embodiment of the coring blade which is attached to the distal end of the chisel shaft.

FIG. 3 is a view of an alternative embodiment of the present disclosure, wherein coring tube 10 has tabs 100 cut into it.

FIG. 4 is a sectional view of tube 10 along a position of coring tube 10 showing detail of an alternative embodiment of tabs 100.

FIG. 5 generally illustrates a method of use of one embodiment of the present disclosure.

FIG. 6 shows an alternative embodiment of the present invention illustrating an oscillating rotation of tube 10.

FIG. 7 shows an alternative distal end for shaft 50.

### DETAILED DESCRIPTION OF THE INVENTION

The present invention relates to an apparatus, and associated methods of operation of such apparatus, for the removal of core material from produce, such as fruits and vegetables. The apparatus comprises a pneumatic chisel, a chisel shaft operatively inserted into the chisel, and a coring tube attached to the distal end of the chisel shaft. Some implementations of the apparatus include tabs cut into the walls of the coring tube, and serrated teeth on the cutting edge of the coring tube. Also described are variable pneumatic power sources, including air, electric, and hydraulic power sources.

The present disclosure also discloses a method of coring produce, the method comprising the steps of placing a cutting tube that is attached to a chisel shaft operatively inserted into a pneumatic chisel against the core of the food item, engaging the power on the pneumatic chisel, cutting through the core of the food item using an oscillatory motion, and removing the cut core from the food item.

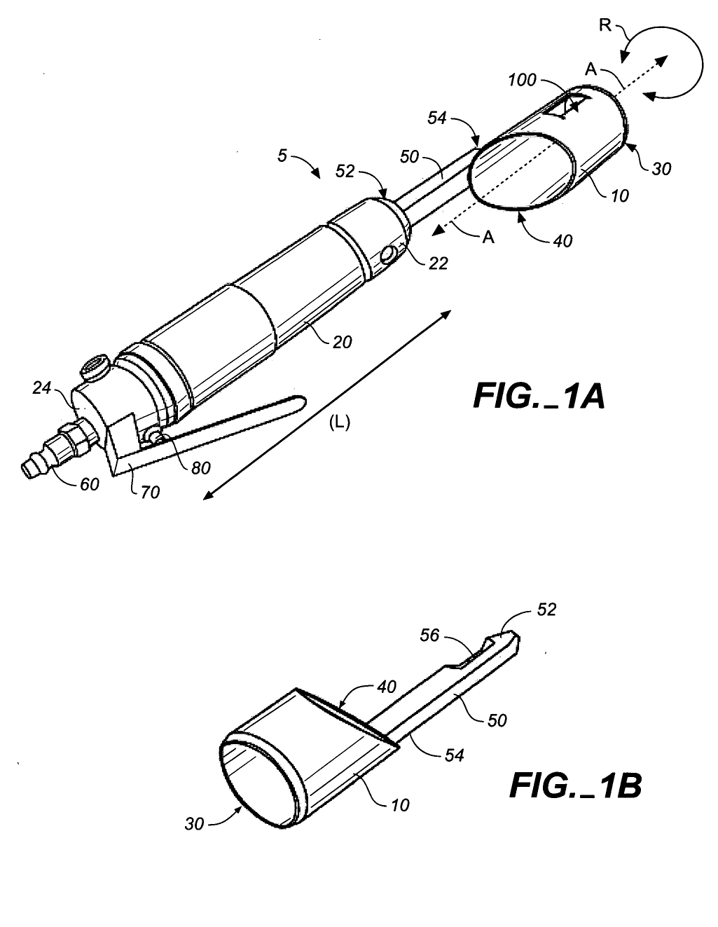

Referring now to the figures, a vegetable corer 5 implementing the present invention is illustrated in FIG. 1A. As shown in the figure, vegetable corer 5 includes a coring tube 10 having distal and proximal ends 30 and 40, respectively. Coring tube 10 is attached to a shaft 50, which in turn is operatively inserted into an internal chamber (not shown) of a pneumatic or electric chisel 20. Coupling 60 connects the chisel 20 to a suitable power source (e.g., pneumatic or electric). The apparatus is operated by movable lever 70, which is biased into an open position by an appropriate means. Depression of lever 70 engages button 80, which in turn activates the pneumatic chisel. In operation, upon engagement of power, the shaft 50 rapidly reciprocates longitudinally within the internal chamber of the pneumatic chisel 20 in rapid, short strokes in a line substantially parallel to line L, and/or with a rotational motion in the directions of arc R, causing coring tube 10 to be driven into the desired section of produce.

Pneumatic chisel 20 generally has a distal end 22 and a proximal end 24, and is preferably generally cylindrical in shape. However, chisel 20 can have any number of known geometrical shapes, including square, rectangular, cylindrical, and the like. Additionally, distal end 22 can be swaged or machined to a reduced diameter at its forward end. Chisel 20 preferably contains a central bore (not shown) within the housing of the chisel at the distal end 22, for receiving chisel shaft 50. Proximal end 24 houses a driving mechanism for the corer 5, one or more hand-operating levers 70 and a power button or switch 80. Further, proximal end 24 of chisel 20 is preferably fitted to the removable coupling 60 connecting the chisel 20 to a power source.

Coupling 60 is shown in FIG. 1A to be a standard male nipple connection, but can be any number of known couplings, including but not limited to male or female latching mechanisms. The chisel 20, as well as coupling 60, can be made out of any suitable material, including but not limited to metal or metal combinations such as steel, stainless steel, anodized steel, steel-metal alloys, aluminum, aluminum alloys, brass, copper, or nickel, as well as hard plastics (PVC, i.e., polyvinyl chloride) and combinations thereof.

The chisel shaft 50 has a proximal end 52 and a distal end 54, as shown in FIGS. 1A and 1B. While shown in FIG. 1B as being generally rectangular in shape, shaft 50 can be substantially square, round, triangular, hexagonal, or any other suitable shape, the only limitation being that the shaft must be able to be operatively inserted at one end into pneumatic chisel 20, and a coring or cutting device must be able to be secured to the opposite end. As shown in FIG. 1B, proximal end 52 is in one embodiment forwardly tapering, and can optionally include annular grooves 56 or other suitable features known in the art suitable for engaging a feature within the central bore of chisel 20 upon operative insertion.

Distal end 54 is preferably secured to coring tube 10 in any number of acceptable attachment means known in the art, the attachment means including but not limited to welds, cements, adhesives, tapes, bolts, screws, rivets, and combinations thereof. Chisel shaft 50, upon operative insertion into pneumatic chisel 20, preferably slides within a central bore of chisel 20, wherein the bore (not shown) is coaxial with the chisel itself. Thus, proximal end 52 is affixed to a longitudinally and/or rotationally reciprocating shaft (not separately shown) coupled to the drive mechanism carried in the housing 24 and driven by the power source via coupling 60.

Similar to the pneumatic chisel 20, chisel shaft 50 can be made of any of a variety of materials, the only proviso being that they have the strength and rigidity to allow operation of produce corer 5 as described herein. Suitable materials include but are not limited to steel, stainless steel, anodized steel, steel-metal alloys, transition-metal steel alloys (e.g., chromium-molybdenum steel), aluminum, brass, and suitably hard and/or coated plastics.

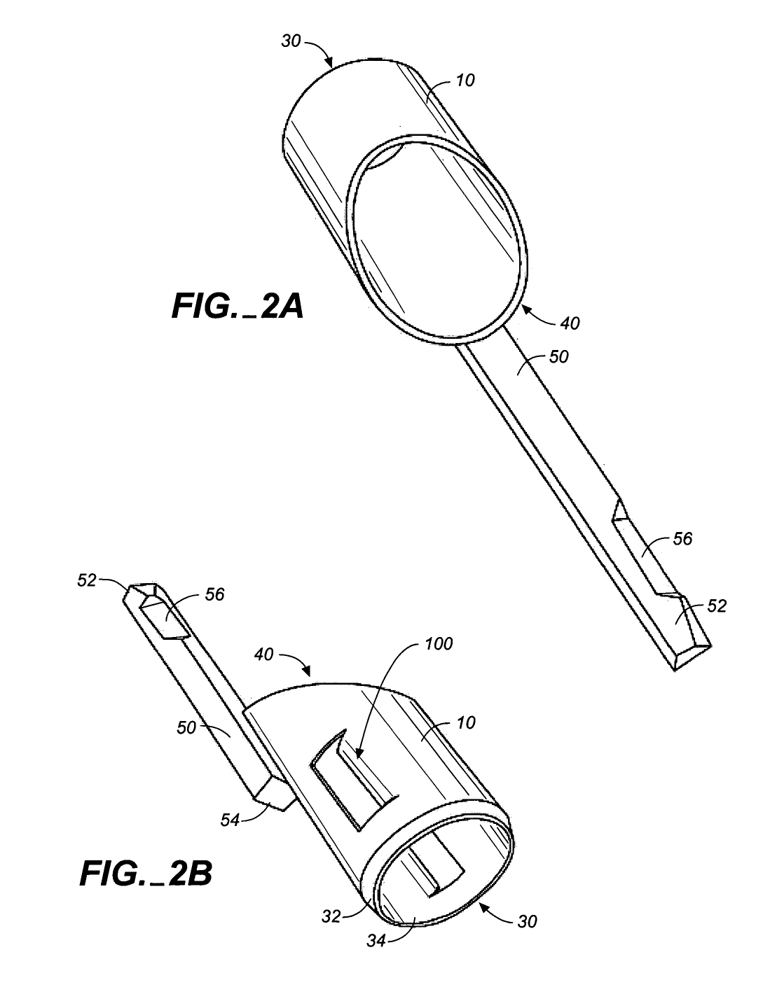

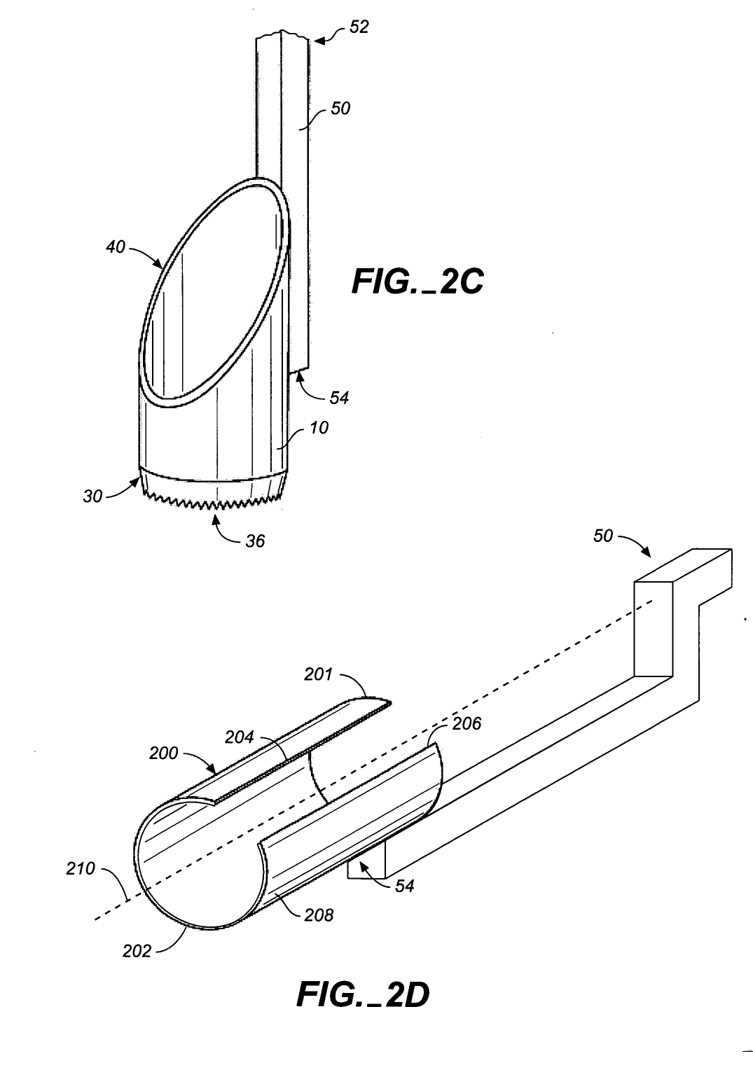

Coring tube 10, as shown in FIGS. 1B and 2A, attached to the distal end 54 of the chisel shaft 50, is substantially cylindrical and hollow, but it is envisioned that it may alternatively be elongated, oval, or any other regular or irregular geometric shape including but not limited to triangular, square, rectangular, hexagonal, octagonal, or any other geometrical shape that provides the desired coring function.

The distal end 30 of the coring tube 10 can have a taper 32 that is sharpened into a coring blade 34 (FIG. 2B), to allow easier penetration of the tube into the produce to be cored. Alternatively, as shown in FIG. 2C, lower distal end 30 of coring tube 10 can have a multitude of sharpened serrations or cutting teeth 36 formed into the cylindrical wall of the coring tube 10. These teeth can be used to further allow the coring apparatus 5 to rapidly and safely core the fruit or vegetable.

In addition to being spaced apart from distal end 30, proximal end 40 can be cut at an angle, and need not be an angle that is perpendicular to the axis of the tube. The angle of proximal end can be from about 0° to about 90° relative to chisel shaft 50. In one embodiment, the angle of proximal end 40 is about 45° relative to the chisel, with the apex of the angle being generally toward the distal end 54 of chisel shaft 50. Similarly, distal end 30 of the coring tube can be substantially perpendicular to the central axis of corer 5 or at a nonperpendicular angle, similar to the angle of proximal end 40. Proximal end 40 is typically maintained to be an open end, such that a core of produce removed by operation of the coring apparatus 5 can exit the coring tube 10, or at least protrude from the proximal end during the coring operation. The nonperpendicular angle for proximal end 40 is selected to assist the exit of a vegetable core as it passes through the coring tube 10.

Coring tube 10 can be removably or permanently secured to chisel shaft 50 by any number of conventional attachment means, including but not limited to welds, cements, bolts, screws and/or rivets, or any other suitable attachment means. Securing coring tube 10 with a removable attachment is advantageous if coring apparatus 5 is to be used in a produce field during harvesting of a vegetable having an especially hard core, such as cabbage. In such an instance, after continual use of coring apparatus 5, the coring edge of the coring tube could become dulled and cause the apparatus to not operate as effectively. Removable attachment of coring tube 10 allows for the rapid field replacement of the coring tube with a minimal amount of lost time and productivity.

Coring tube 10 can be made from any suitable material sufficiently strong as to allow successful operation of the coring apparatus 1 as described in the present disclosure. Suitable materials for coring tube 10 include but are not limited to steel, stainless steel, anodized steel, steel-metal alloys, titanium, vanadium, chromium-molybdenum steel alloys, and suitably hard or coated plastics.

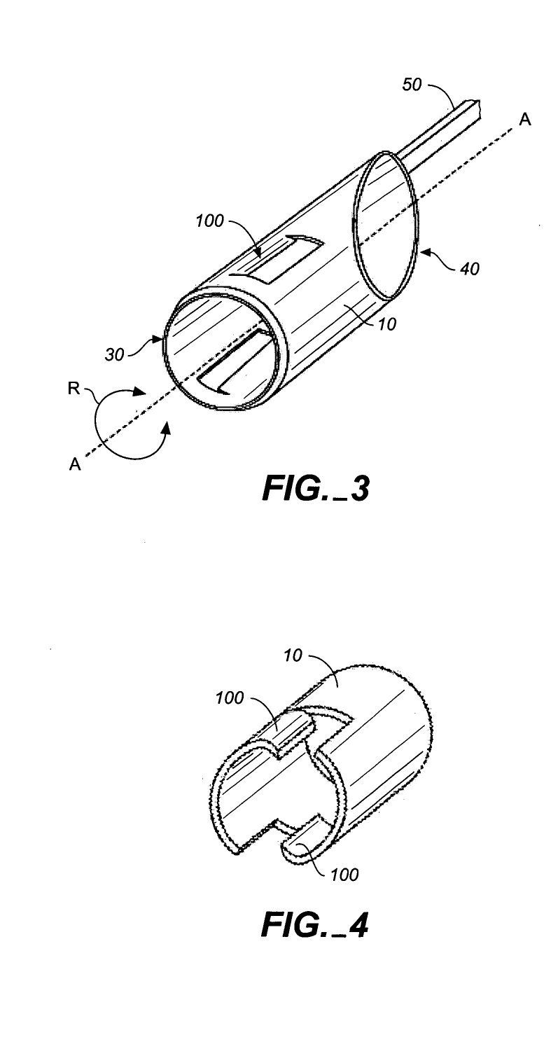

An optional feature of the present disclosure is shown in FIGS. 2B, 3 and 4, wherein one or more tabs 100 are cut into the sidewall of coring tube 10. As shown in FIG. 4, illustrating a cut-away view of coring tube 10 to better show tabs 100, the tabs are preferably bent inwards, toward the center of tube 10. The tabs 100 thereby form a secondary blade running in the same direction as the rotary motion R of the chisel—that is, rotationally around the longitudinally oscillating axis A of coring apparatus 5 (FIG. 3). These secondary blades allow for easier penetration of the core material, while simultaneously providing a “grip” on the core material so that it cannot rotate inside coring tube 10 when the tube is twisted to remove the core itself. In one embodiment of this feature, the tab 100 is cut from an approximately one-inch arc of the corer 10, and is bent inward approximately three-eighths of an inch. In accordance with the present disclosure, tabs 100 can be larger or smaller, and can be bent inwardly to a greater or lesser degree as necessitated by the use of corer 5 with various types and sizes of vegetable or fruit crops.

Another aspect of coring tube 10 is shown in FIG. 2D, wherein coring tube 200 is cylindrical in shape and has a center of curvature that is substantially aligned with the longitudinal center rotating axis 210 of the chisel shaft 50. The cutting portion includes two substantially parallel edges 204 and 206 that are spaced apart by an angular distance with respect to the center of curvature of more than about 270°, but less than 360°, such that a gap 207 of about 90° or less is defined therebetween (e.g., about 30° in the embodiment shown in FIG. 2D). The cutting portion end 202 can have multiple cutting teeth, such as described above and shown in FIG. 2C. Such teeth can be used to saw into the produce, such as a cabbage head, with the cutting portion sized to have a radius larger than the radius of the core of the produce to be cored. Rotating motion of the device is about the longitudinal centerline/axis 210.

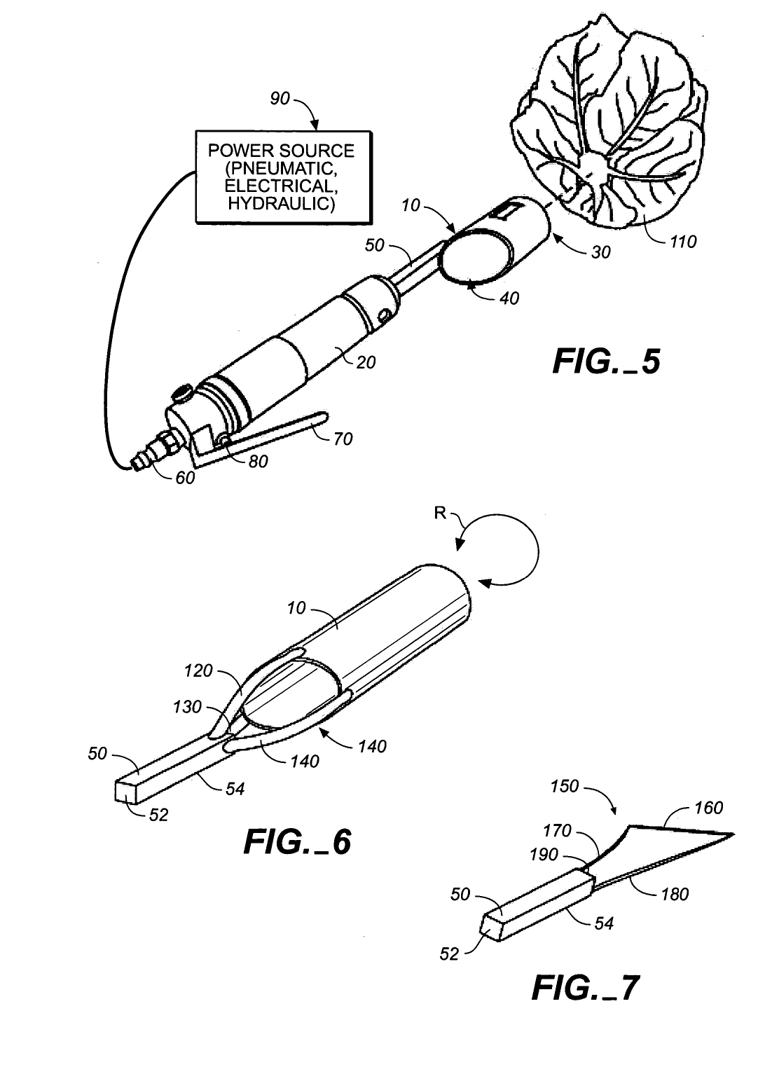

In a pneumatically driven embodiment, chisel 20 is powered by an air distributing mechanism that reciprocates the operatively inserted shaft 50 in response to a supply of compressed fluid or air. Any of the number of pneumatic chisels known in the art are envisioned to be adaptable for use with the present invention. The chisel 20 can thus be powered by any of a variety of known power sources 90, which can be adapted to provide a driving force to chisel 20. As shown in FIG. 5, such a power source 90 can include, but is not limited to, pneumatic drivers, electrical motors and related electrical apparatuses, hydraulic drivers, motors, and related hydraulic apparatuses, and similar power sources known in the art.

As illustrated in both FIG. 1A and FIG. 5, the coupling 60 at the proximal end 24 of the pneumatic chisel 20 connects the chisel to a pneumatic pump, hydraulic pump, electric pump, compressed air source, or the like. The chisel 20 is operated by a lever 70, which engages a button or switch 80 when depressed. This in turn allows the compressed air or other suitable mechanism to operate chisel 20 in a conventional fashion. Lever 70 is preferably biased into its open position by any conventional devices known in the art, including but not limited to a spring, a solenoid, compressed air, or the like.

Multiple buttons and/or levers may be provided for multiple modes of operation. For instance, a dual-function lever may engage a first button for longitudinal reciprocation and a second button for rotational reciprocation. In embodiments incorporating rotational reciprocation, the rotational axis of shaft 50 is substantially aligned with the axis of the cover 10.

As described previously, the motion of pneumatic chisel 20 during typical operation can be longitudinally forward and backward in rapid, short strokes, such as along line (L) in FIG. 1A, wherein such motion is substantially parallel to chisel shaft 50. In such an embodiment, the thrusting motion of the chisel is back and forth along the axis A of the coring tube 10.

In another embodiment, as discussed above, a rotational motion R as shown in FIG. 1A can be imparted to coring tube 10, which is affixed to shaft 50 in a manner such that the axis of the coring tube 10 substantially aligns with the axis of the drive shaft 50. Upon engagement of the power source, coring apparatus 5 is placed against the core of a vegetable or fruit and the core removed by rotationally coring out the center of the food item. Such a rotational motion R of coring tube 10 can be coupled with longitudinal oscillation L along chisel shaft 50, thereby further enhancing the efficiency and speed at which apparatus 5 removes the core from produce.

Another embodiment, illustrated in FIG. 6, the opening of the coring tube 10 at its proximal end 40 is maintained substantially unimpeded by arms 120, 130 and 140 connecting chisel shaft 50 with the proximal end 40 of coring tube 10. Other, similar connection configurations can be had that maintain the opening at the proximal end 40 so as to allow a vegetable core to exit the coring tube 10, or at the least protrude from the proximal end 40 during the coring operation to provide for easy removal of the core from the coring tube.

An alternative use for the apparatus of the present disclosure is in the harvesting of fibrous woody crops such as brussels sprouts. In this embodiment, the chisel shaft 50 may have a flat knife 150 such as shown in FIG. 7 attached. Knife 150 is shaped generally like a putty knife and has a sharpened distal cutting end 160 and sides 170 and 180. Sides 170 and/or 180 can also be sharpened similar to distal cutting end 160. Knife 150 also has a proximal end 190, by which the blade is affixed to the distal end 54 of the shaft 50. Chisel shaft 50, as in previous embodiments, is linked to the power source 90 by operative insertion into pneumatic chisel 20. Attachment of knife 150 to the distal end of a chisel shaft 50 can be permanent or removable. If knife 150 is permanently attached to the chisel shaft, attachment can be by any known and acceptable attachment mechanism, such as by insertion into a slot in shaft 50 sized to receive knife 150, or by forming both chisel shaft 50 and knife 150 from the same piece of material. If knife 150 is removably attached to chisel shaft 50, attachment can be by any nonpermanent attachment means known in the art.

In operation, the knife 150 is positioned such that cutting edge 160 is against the stalk of the plant where the cut is to be made, and the power source 90 is engaged. Using this embodiment in a method similar to that described generally above, the stalk of the plant (e.g., brussels sprout) is quickly and easily severed from the root system, without undue exertion by or danger to the operator.

It is envisioned that the apparatus of the present disclosure can be used on any type of produce having a core or similar portion which it is desirable to remove.

In a typical method of operation of the coring tool 5 of the present disclosure, the coring blade at distal end 30 of the coring tube 10 is aligned against the core of vegetable 110, as shown in FIG. 5. Pressure is applied by the operator, causing the distal end 30 of the coring tube 10 to be firmly placed against the vegetable core, whereby the coring blade at distal end 30 of the coring tube enters the produce item. The pneumatic chisel 20 is then activated by engaging lever 70 and depressing button 80. Chisel shaft 50 then proceeds to oscillate longitudinally forward and backward in rapid, short strokes along an axis L parallel to drive shaft 50, and in doing so circularly cuts around the core of the produce item. Upon reaching the desired depth in the core, the chisel is deactivated by again disengaging lever 70 and releasing button 80, and the coring blade at distal end 30 is withdrawn from the produce item with the core captured inside the coring tube 10. Optionally, and equally acceptable, the entire unit 5 is rotated manually by approximately one quarter turn in either a clockwise, counterclockwise, or both directions in order to dislodge the innermost tip of the core from the usable portion of the head of the vegetable. The core is then withdrawn from the produce item, as described above. Because the apparatus can be handheld (or mounted in a stationary location) and can be operated with minimal effort, the likelihood of operator injury and stress is greatly reduced. Further, owing to the lack of continual, rapid rotation of the coring tube (although an additional oscillating rotational motion is possible, as described previously), there is minimal danger of operator hair or clothing being caught and dragged into the device.

All of the methods, processes and/or apparatus disclosed and claimed herein can be made and executed without undue experimentation in light of the present disclosure. While the methods of this invention have been described in terms of preferred embodiments, it will be apparent to those of skill in the art that variations may be applied to the methods, apparatus and/or processes and in the steps or in the sequence of steps of the methods described herein without departing from the concept and scope of the invention. All such similar substitutes and modifications apparent to those skilled in the art are deemed to be within the scope and concept of the invention. Further, it should be appreciated that the present invention provides many applicable inventive concepts which can be embodied in a wide variety of contexts.

1. An apparatus for coring produce, the apparatus comprising:
a tool housing containing an apparatus for producing a driving force, the housing having a proximal end and a distal end;
a shaft having a proximal end and a distal end, the shaft disposed for reciprocation within an internal chamber of the tool housing; and
a coring tube having a proximal end and a distal end,
wherein the proximal end of the shaft is operatively coupled to the tool housing to receive the driving force, and the coring tube is attached to the distal end of the shaft.

2. The apparatus of claim 1, wherein the apparatus for producing a driving force is selected from the group consisting of pneumatic drivers, air drivers, electric motors, and hydraulic motors.

3. The apparatus of claim 1, wherein the driving force produced includes at least one of a linear reciprocation and an oscillatory rotation.

4. The apparatus of claim 1, the coring tube further comprising a coring blade on the distal end of the coring tube.

5. The apparatus of claim 4, wherein the coring blade comprises cutting teeth located on the distal end of the coring tube.

6. The apparatus of claim 1, wherein the coring tube has a cylindrical geometric shape.

7. The apparatus of claim 1, wherein the proximal end of the coring tube is cut at an angle between about 20° and about 80°.

8. An apparatus for coring cabbage, the apparatus comprising:
a tool housing containing an apparatus for producing a driving force, the housing having a proximal end and a distal end;
a shaft having a proximal end and a distal end, disposed for reciprocation within an internal chamber of the tool housing; and
a coring tube having a proximal end and a distal end,
wherein the coring tube is attached to the distal end of the shaft.

9. The apparatus of claim 8, wherein the driving force produced at least one of a linear reciprocation and an oscillatory rotation.

10. The apparatus of claim 8, wherein the coring tube has a generally cylindrical geometric shape.

11. The apparatus of claim 8, the coring tube further comprising a coring blade on the distal end.

12. The apparatus of claim 11, wherein the coring blade comprises cutting teeth located on the distal end of the coring tube.

13. An apparatus for harvesting produce, the apparatus comprising:
a tool housing containing an apparatus for producing a driving force, the housing having a proximal end and a distal end;
a shaft having a proximal end and a distal end, disposed for reciprocation within an internal chamber of the tool housing; and
a cutting knife;
wherein the cutting knife is attached to the distal end of the shaft.

14. A method of coring produce, including the steps of:
placing the produce in position for coring;
aligning a powered coring apparatus including a power-driven reciprocating chisel and an attached coring tube against a core of a vegetable, such that the core of the produce is substantially encompassed by the area defined by the inside of the coring tube;
engaging the power of the coring apparatus;
driving the coring tube into the core of the vegetable by a reciprocating motion from the chisel; and
removing the core.

15. An apparatus for coring produce, including:
a power tool contained within a tool housing;
a reciprocally moving shaft having a proximal end and a distal end, being operatively disposed at the proximal end for reciprocation within an internal chamber of the housing; and
a coring device;
wherein the coring device is attached to the distal end of the reciprocally moving shaft.
